(19) United States
(12) Patent Application Publication
(10) Pub. No.: US 2019/0104831 A1
(43) Pub. Date: Apr. 11, 2019

(54) HOLSTER FOR AN ELECTRONIC DEVICE

(71) Applicant: Molly Lazzara, Denver, CO (US)

(72) Inventor: Molly Lazzara, Denver, CO (US)

(21) Appl. No.: 16/152,689

(22) Filed: Oct. 5, 2018

Related U.S. Application Data
(60) Provisional application No. 62/569,017, filed on Oct. 6, 2017.

(51) Int. Cl. A45F 5/02; H04B 1/3888

(52) U.S. Cl. CPC A45F 5/02; A45F 2200/0516; H04B 1/3888

(57) ABSTRACT

A holster and methods of use are provided for storing a smartphone or other electronic device of a user in motion. The holster includes a protection pocket with an open top end configured to receive the device. The holster also includes a closure flap disposed adjacent to the open top end and configured to move between an open position in which the device is exposed and a closed position in which the device is fully enveloped within the protection pocket and the closure flap. The holster may further include an adjustable flap fastener configured to secure the closure flap against the front surface of the protection pocket at a variety of heights to accommodate different device footprints, and an adaptable attachment mechanism configured to selectively secure the holster in an attached configuration upon the user's appendage or an article of the user's clothing. Other embodiments are also disclosed.

### REFERENCE TO PENDING PRIOR PATENT APPLICATIONS

This application claims the benefit under 35 U.S.C. 119(e) of U.S. Provisional Patent Application No. 62/569,017, filed Oct. 6, 2017 by Molly Lazzara for “PHONE HOLSTER,” all of which patent application is hereby incorporated herein by reference.

### BACKGROUND

Mobile devices such as smartphones and other handheld phones and/or electronic devices are generally difficult to secure relative to a person in motion during activities such as running, walking, biking, hiking, and so on. Due to this difficulty, runners, joggers, walkers, hikers, and/or other users oftentimes place their devices into extraneous and bulky bags, backpacks, fanny packs, or other types of carriers. Others attempt to store devices within their clothing such as a frictional fit beneath the straps or panels of a sports bra or fitted tank top next to the skin, which can irritate the skin and damage the device through exposure to heat and sweat. Others have attempted to solve the problem of securing a mobile device directly to a user's hand, arm, or clothing, but these solutions present significant challenges. For example, arm bands exist to secure phones or other mobile devices about a user's arm. The securement mechanisms on the arm bands are generally not strong enough to hold today's large-footprint devices in place, and the materials are oftentimes susceptible to heat and moisture and lack pliability, durability, and cannot easily be cleaned. In addition, some types of exercise clothing (e.g., running leggings, etc.) feature built-in pockets that may be used to house mobile devices, but these pockets are oftentimes difficult to access, lack any type of securement mechanism to hold the device therein, and cannot be adjusted to fit the footprint of the particular device being stored.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a holster for storing an electronic device of a user in motion. The holster may include: (1) a protection pocket having a front surface, a rear surface, and an open top end configured to receive the electronic device; (2) a closure flap attached to the open top end of the protection pocket, the closure flap configured to move between an open position in which the electronic device is exposed at the open top end of the protection pocket and an adjustable closed position in which the electronic device is fully enveloped within the protection pocket and the closure flap; (3) an adjustable flap fastener configured to secure the closure flap in the adjustable closed position, wherein when the closure flap is in the adjustable closed position, the protection pocket and the closure flap have a combined height that approximates a height of the electronic device; and (4) an adaptable attachment mechanism configured to selectively secure the holster in an attached configuration to a body part or a clothing article of the user.

Another embodiment provides a soft-sided smartphone mounting holster. The mounting holster may include (1) a protection pocket configured to alternately receive at least a first smartphone having a first height and a second smartphone having a second height, the protection pocket having a closed bottom end and an open top end; (2) a closure flap affixed at the open top end of the protection pocket; (3) an adjustable flap fastener configured to secure the closure flap over the open top end of the protection pocket in at least first and second closed positions, the first closed position resulting in a first height of the mounting holster to fully envelop the first smartphone within the protection pocket and the closure flap and the second closed position resulting in a second height of the mounting holster to fully envelop the second smartphone within the protection pocket and the closure flap; and (4) an adaptable attachment mechanism configured to move between a detached configuration and an attached configuration in which the smartphone holster is secured to a user's appendage or an item of the user's clothing.

Yet another embodiment provides a method of attaching a holster housing an electronic device to an appendage or clothing article of a user, the holster including a protection pocket having an open top end, a closure flap, an adjustable flap fastener, and an adaptable attachment mechanism. The method may include the following steps: (1) inserting the electronic device into the open top end of the protection pocket; (2) using the adjustable flap fastener, securing the closure flap to a select location on the protection pocket, the select location resulting in a combined height of the protection pocket and the closure flap that approximates the electronic device such that the electronic device is fully enveloped within the protection pocket and the closure flap; and (3) using the adaptable attachment mechanism, securing the holster about the user's appendage or the user's clothing article.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a perspective-exploded view of one embodiment of a phone holster in an open position to receive an electronic device;

FIG. 2 illustrates a front view of the holster of FIG. 1 in a first closed position that accommodates an electronic device of a first height;

FIG. 3 illustrates a front view of the holster of FIG. 1 in a second closed position that accommodates an electronic device of a second height;

FIG. 4 illustrates a rear view of the holster of FIG. 1 in a detached configuration;

FIG. 5 illustrates a rear view of the holster of FIG. 1 in a detached configuration in which an adjustable attachment strap is extended through a strap return;

FIG. 6 illustrates a rear view of the holster of FIG. 1 in an attached configuration;

FIG. 7 shows a rear perspective view of the holster of FIG. 1 in an attached configuration upon a user's hand;

FIG. 8 shows a front perspective view of the holster of FIG. 1 in an attached configuration upon a user's hand; and

FIG. 9 provides a flowchart depicting an exemplary method of securing the holster of FIG. 1, along with an electronic device contained therein, to a user's appendage or article of clothing.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Various embodiments of the systems and methods described herein relate to the securement of a mobile device such as a smartphone to a user's body (e.g., a user's hand, arm, calf, etc.) or clothing while the user is in motion. As discussed above in the Background section, existing solutions present a number of functionality, convenience, and durability challenges such that there is not a suitable securement mechanism available to today's active users of mobile technology.

Embodiments of a phone holster disclosed herein are designed to address the particular challenges presented by existing device securement solutions by providing a wearable and adjustable securement mechanism that securely attaches to a user's hand, clothing, or other body part in a manner that provides a high degree of device protection without causing irritation to the skin or damage to the user's clothing, and that is convenient to both use and clean.

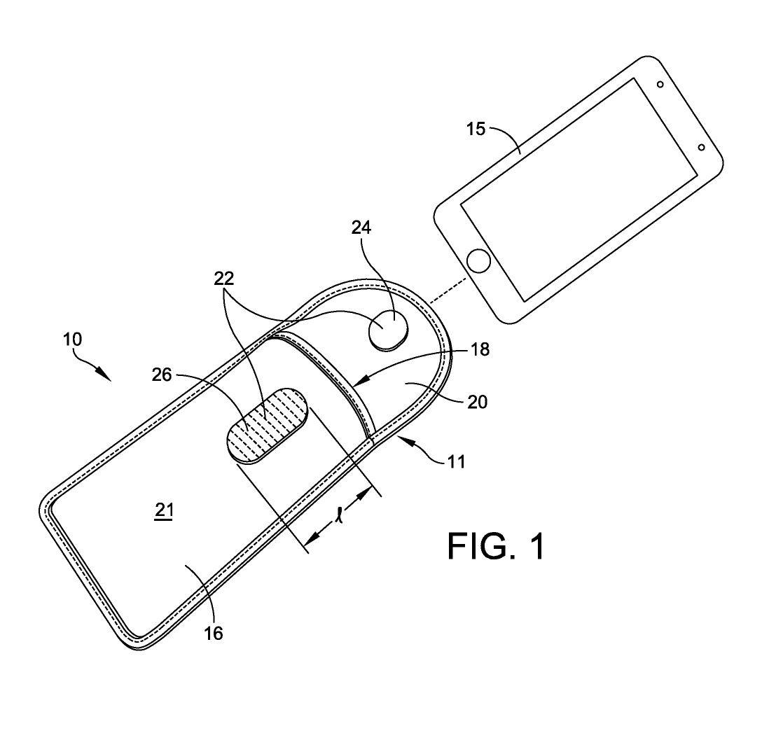

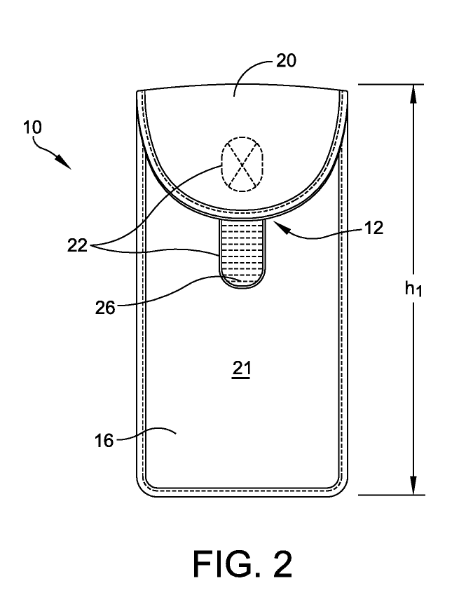

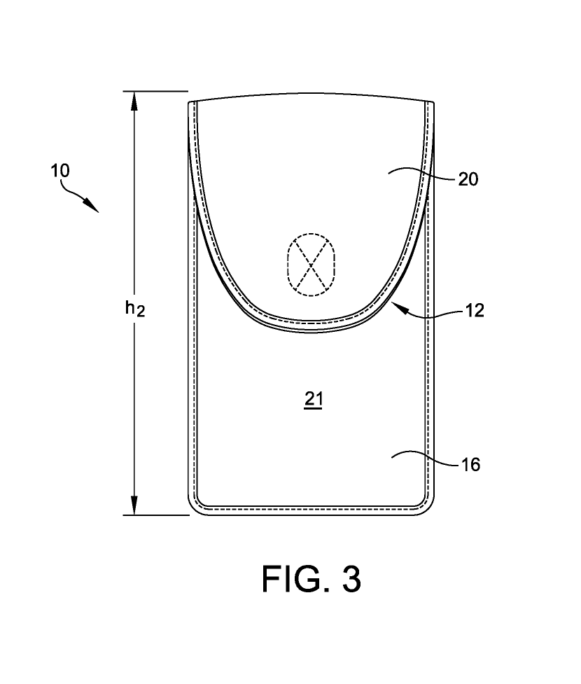

Turning to exemplary embodiments, FIG. 1 illustrates a perspective view of one embodiment of a wearable phone holster 10 in an open position 11 and for use in securing a smartphone or other electronic device 15 to a user's hand, other body part, or clothing. FIGS. 2-3 illustrate front views of the phone holster 10 in an adjustable closed position 12 that enables the holster 10 to accommodate electronic devices having different footprints.

In this embodiment, the holster 10 may include a protection pocket 16 having an open top end 18 configured to receive a user's electronic device 15 such as, for example, a smartphone. In one embodiment, the protection pocket 16 may be lined with any appropriate flexible, malleable, and/or shock-dampening material to further protect the device 15. The holster 10 may also include a closure flap 20 and an adjustable flap fastener 22. In this embodiment, the adjustable flap fastener 22 may include a top securement patch 24 affixed to the closure flap 20 and a bottom securement strip 26 affixed to a front surface 21 of the protection pocket 16, both configured for securing the closure flap 20 in the adjustable closed position 12 over the open top end 18 of the protection pocket 16.

To close the pocket 16, and thus to fully envelop the device 15 within the protection pocket 16 and the closure flap 20, the top securement patch 24 may be pressed against or mated with the bottom securement strip 26 at a select or desired location along a length, l, of the securement trip 26 to achieve a desired height, h₁₋ₙ, of the holster 10, or of the combined protection pocket 16 and the closed closure flap 20.

The ability to mate the adjustable flap fastener 22 at a select location or height enables the holster 10 to accommodate a variety of devices (e.g., smartphones) of varying sizes and ensures that devices of varying sizes are fully enveloped by the protection pocket 16 and the closure flap 20 when the closure flap 20 is in the adjustable closed position 12, as shown in FIGS. 2-3. In one embodiment, the bottom securement strip 26 may be configured to provide at least 1 inch of height adjustability. In some embodiments, the top securement patch 24 and the bottom securement strip 26 may be formed of opposing portions of hook-and-loop fastener material such as, for example, opposing portions of Velcro material. In other embodiments, the top securement patch 24 and the bottom securement strip 26 may be formed of any appropriate and adjustable fastening materials and/or mechanisms (e.g., snaps, hooks, buttons, etc.).

When in use, the user's phone or other electronic device—regardless of the device's height/footprint—is fully enclosed or enveloped within the secure protection pocket 16 and the closure flap 20, thereby protecting the phone from moisture (e.g., sweat, rain, humidity), inadvertent impact, and other elements.

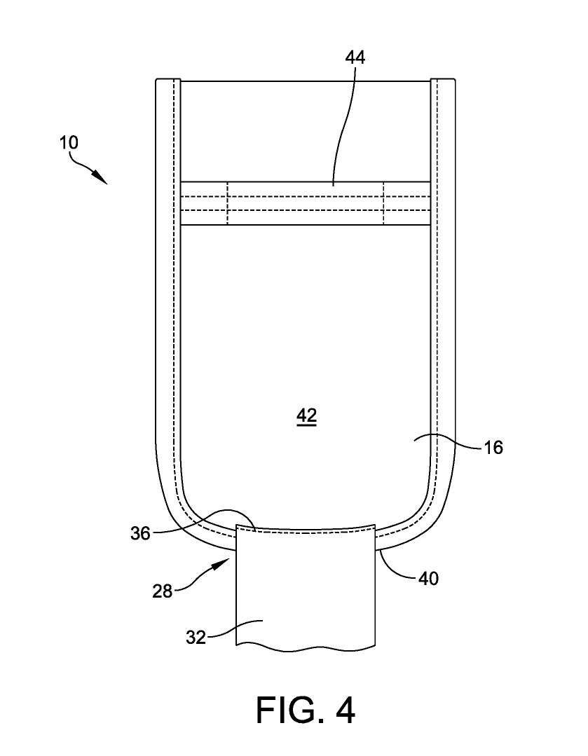

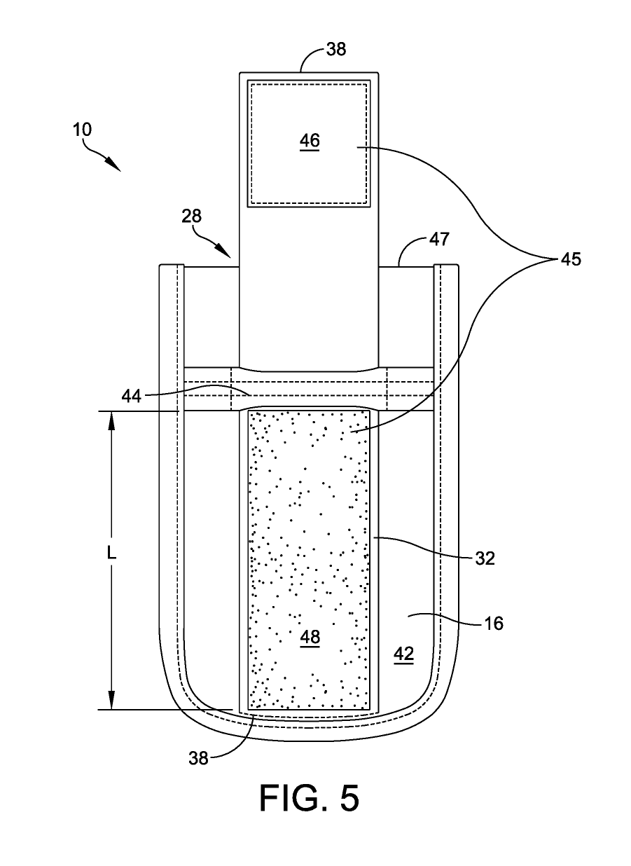

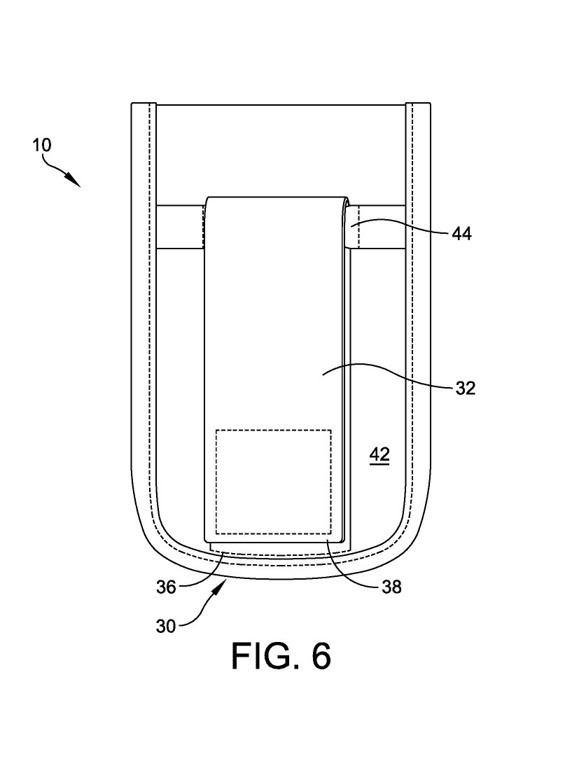

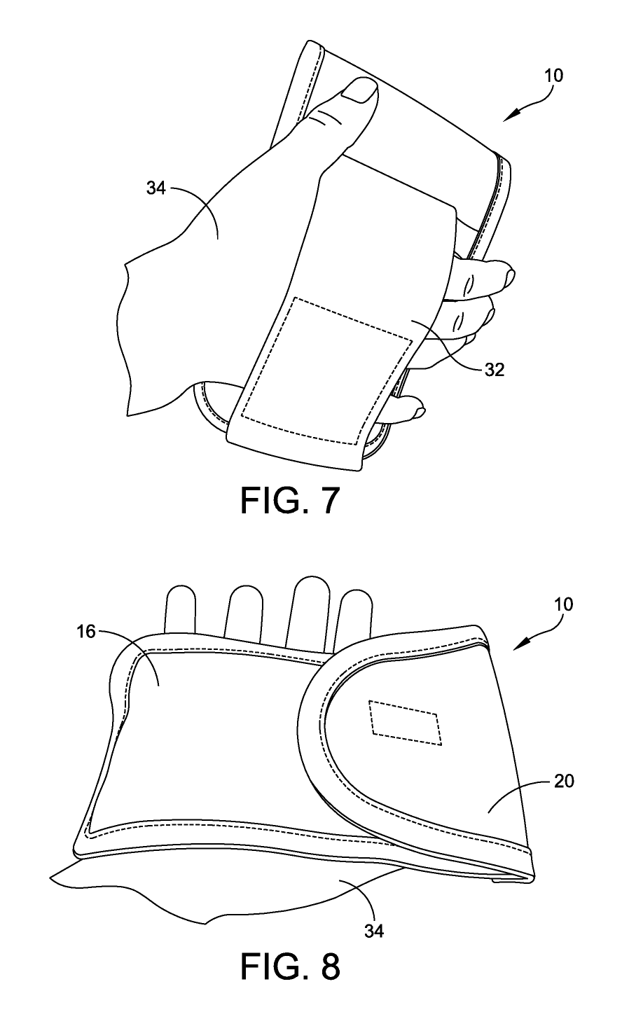

FIGS. 4-5 illustrate rear views of one embodiment of the holster 10 in a detached configuration 28, while FIG. 6 illustrates a rear view of the holster 10 in an attached configuration 30. In one embodiment, the holster 10 may include an adaptable attachment mechanism for securing the holster to the user's person or clothing. In this embodiment and as shown in FIGS. 4-6, the adaptable attachment mechanism may include an adjustable attachment strap 32 configured to tighten or secure the holster about the user's hand, about another portion of the user's body, or about an article of the user's clothing when in the attached configuration 30. To demonstrate, FIGS. 7-8 illustrate front and rear views of the holster 10 in the attached configuration 30 about a user's hand 34.

Returning to FIGS. 4-6 and in this embodiment, the attachment strap 32 may have first and second opposing ends 36, 38, respectively. The first end 36 may be affixed (e.g., sewn) to a bottom portion 40 of a back surface 42 of the protection pocket 16, and the second free end 38 may loop about a strap return 44 that extends across a top portion 47 of the back surface 42 of the protection pocket 16. The strap return 44 may be any appropriate return mechanism about which the adjustable attachment strap 32 may traverse a return loop. For example, the strap return 44 may be a flexible (e.g., fabric) strap-reversing loop sewn or otherwise affixed to the back surface 42 of the protection pocket 16 or may be a rigid bar affixed to the back surface 42 of the protection pocket 16.

The attachment strap 32 of the adaptable attachment mechanism may also include an adjustable strap fastener 45 for securing the attachment strap 32 at a desired tightness about a portion of the user's body or clothing. In this embodiment, the adjustable strap fastener 45 may include a top attachment patch 46 and a bottom attachment strip 48 that oppose one another when the second free end 38 of the adjustable attachment strap 32 is looped about the strap return 44.

In use, the second free end 38 of the adjustable attachment strap 32 may be extended through and looped about the strap return 44 and tightened, or leveraged against the strap return 44, before the top attachment patch 46 is mated to the bottom attachment strip 48 at a select or desired location along a length, L, of the attachment strip 48 to achieve a desired tightness about the user's person or clothing. In one embodiment, the top attachment patch 46 and the bottom attachment strip 48 may be formed of opposing portions of hook-and-loop fastener material such as, for example, opposing portions of Velcro. In other embodiments, the top attachment patch and the bottom attachment strip may be formed of any appropriate and adjustable fastening materials and/or mechanisms (e.g., hooks, snaps, buckles, buttons).

In this embodiment, the adjustable attachment strap 32 may be looped, tightened, and fastened about the user's clothing (e.g., a razorback portion of a sports bra, a fabric loop on the user's shorts or pants, a tank top strap, a belt, etc.) such that the user's clothing is disposed between the back surface 42 of the protection pocket 16 and the attachment strap 32. Alternatively, the strap 32 it may be looped, tightened, and fastened about the user's hand, as shown in FIGS. 7-8, or about another desirable body part (e.g., an upper arm, forearm, calf, etc.) such that the protection pocket 16 lies adjacent to the user's skin. In one embodiment, the adjustable attachment strap 32 of the holster 10 may also be looped about a collar or harness strap that is attached to the user's pet.

The various components of the holster 10 may be formed from comfortable, flexible, and wearable materials to facilitate wearing the holster directly against the user's skin. The materials forming the holster 10 may also be water resistant to provide protection from sweat, rain, and/or other elements and machine washable in a standard washing machine. In one embodiment, the materials may include one or more of Supplex®, cotton, spandex, polyester, and/or associated fabric blends. The holster 10 may have any appropriate dimensions to encompass a variety of device footprints.

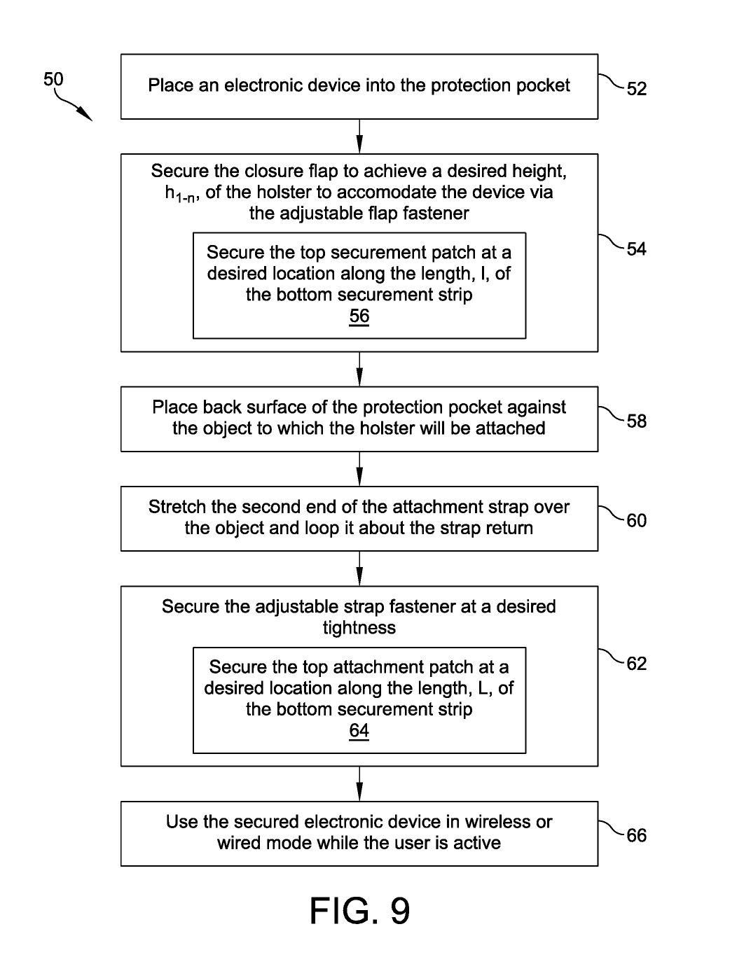

FIG. 9 provides a flowchart depicting an exemplary method (50) of attaching an electronic device to a user's body or item of clothing using an embodiment of the holster 10, discussed above. The method (50) begins when the user places his or her electronic device such as, for example, a smartphone into the protection pocket 16 of the holster (52) and secures the closure flap 20 in the adjustable closed position 12 that provides a desired height, h₁₋ₙ, of the holster 10 to accommodate the footprint of the device via the adjustable flap fastener 22 (54). Securing the adjustable flap fastener 22 to secure the closure flap 20 and close the closure flap 20 (54) may involve securing the top securement patch 24 at a select or desired location along the length, l, of the bottom securement strip 26 (56).

Once the device 15 is secured within the protection pocket 16 via the closure flap 20 (54), the back surface 42 of the protection pocket 16 may be placed against an object upon or to which the holster 10 will be mounted or attached (58) (e.g., a hand, calf, bicep, tank top strap, bra strap, bra razorback, dog collar, etc.). Then the second free end 38 of the adjustable attachment strap 32 may be stretched over the object and looped about and tightened against the strap return 44 (60) before the adjustable strap fastener 45 is secured at a desired tightness (62) to secure the holster 10 to the object. Securing the adjustable strap fastener 45 to secure the holster 10 (62) may involve securing the top attachment patch 46 to the bottom attachment strip 48 at a desired location along the length, L, of the bottom attachment strip 48 (64). Once the holster 10 is secured to the user's person, clothing, or another object (62), the electronic device enveloped therein may be used in wireless mode (e.g., Bluetooth mode) or another wired mode (e.g., via wired headphones or microphone) while the user is actively engaged in motion such as hiking, biking, running, and so on (66).

Embodiments of the holster 10 and associated methods of use described above provide numerous advantages over existing alternatives. The holster 10 is fully adjustable to accommodate a variety of device footprints and/or sizes and may be securely attached to either the user's person or his or her clothing, such that the holster 10 and the phone or other device contained therein do not shift when the user moves (e.g., runs, hikes, walks, bikes). The holster 10 completely envelops the device—without any type or kind of use panel or touchscreen-access panel or opening—with components that are entirely formed from shock-dampening and waterproof, yet easily washable materials that do not irritate the user's skin. Thus, the device/phone is fully protected against inadvertent forces and moisture or other environmental contaminants, but the user can still interact with the device via Bluetooth® and/or other wireless technologies and/or via traditional wired headphones that exit the top end 18 of the protection pocket 16 where the pocket meets the closure flap 20. Embodiments of the holster 10 are formed entirely of flexible and malleable padded materials that act as dampening agents in the event the holster and device are dropped or otherwise impacted or subject to force. Unlike rigid materials, which form at least the backbone or framework of many existing device cases, the malleable, padded, and shock-absorbent materials of the holster 10 do not conduct forces to the device upon impact. The holster provides superior wearable functionality and ease of use in a streamlined, low-profile, durable design.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A holster for storing an electronic device of a user in motion, comprising:
a protection pocket having a front surface, a rear surface, and an open top end configured to receive the electronic device;
a closure flap attached to the open top end of the protection pocket, the closure flap configured to move between an open position in which the electronic device is exposed at the open top end of the protection pocket and an adjustable closed position in which the electronic device is fully enveloped within the protection pocket and the closure flap;
an adjustable flap fastener configured to secure the closure flap in the adjustable closed position, wherein when the closure flap is in the adjustable closed position, the protection pocket and the closure flap have a combined height that approximates a height of the electronic device; and
an adaptable attachment mechanism configured to selectively secure the holster in an attached configuration to a body part or a clothing article of the user.

2. The holster of claim 1, wherein:
the adjustable flap fastener comprises a top securement patch disposed on the closure flap and a bottom securement strip disposed on the front surface of the protection pocket; and
the top securement patch and the bottom securement strip mate at a select location along a length of the bottom securement strip when the closure flap is in the adjustable closed position.

3. The holster of claim 2, wherein the top securement patch and the bottom securement strip are formed from opposing portions of hook and loop fastener material.

4. The holster of claim 1, wherein the adaptable attachment mechanism comprises:
an adjustable attachment strap having a first end affixed to a bottom portion of the back surface of the protection pocket and a second free end;
a strap return affixed to a top portion of the back surface of the protection pocket; and
an adjustable strap fastener, wherein when in the attached configuration:
the second free end of the attachment strap loops about and leverages against the strap return; and
the second free end of the attachment strap mates to a portion of the attachment strap adjacent the first end of the attachment strap via the adjustable strap fastener.

5. The holster of claim 4, wherein:
the adjustable strap fastener comprises a top attachment patch disposed adjacent the second free end of the attachment strap and a bottom attachment strip disposed adjacent the first end of the attachment strap, and
when in the attached configuration, the top attachment patch and the bottom attachment strip mate at a select location along a length of the bottom attachment strip.

6. The holster of claim 5, wherein the strap return comprises a flexible strap-reversing loop.

7. The holster of claim 1, wherein the protection pocket, the closure flap, the adjustable flap fastener, and the adaptable attachment mechanism are each formed of a flexible and malleable material.

8. The holster of claim 1, wherein the electronic device comprises a smartphone.

9. The holster of claim 1, wherein the protection pocket lacks a user interface window.

10. The holster of claim 1, wherein the body part comprises a hand and the clothing article comprises one of a razor back of a bra and a strap of a tank top.

11. A soft-sided smartphone mounting holster, comprising:
a protection pocket configured to alternately receive at least a first smartphone having a first height and a second smartphone having a second height, the protection pocket having a closed bottom end and an open top end;
a closure flap affixed at the open top end of the protection pocket;
an adjustable flap fastener configured to secure the closure flap over the open top end of the protection pocket in at least first and second closed positions, the first closed position resulting in a first height of the mounting holster to fully envelop the first smartphone within the protection pocket and the closure flap and the second closed position resulting in a second height of the mounting holster to fully envelop the second smartphone within the protection pocket and the closure flap; and
an adaptable attachment mechanism configured to move between a detached configuration and an attached configuration in which the smartphone holster is secured to a user's appendage or an item of the user's clothing.

12. The soft-sided smartphone mounting holster of claim 11, wherein:
the adjustable flap fastener comprises a top securement patch disposed on the closure flap and a bottom securement strip disposed on the front surface of the protection pocket; and
the top securement patch and the bottom securement strip mate at a first select location along a length of the bottom securement strip when the closure flap is in the first closed position and at a second select location along the length of the bottom securement strip when the closure flap is in the second closed position.

13. The soft-sided smartphone mounting holster of claim 11, wherein the adaptable attachment mechanism comprises:
an adjustable attachment strap having a first end affixed to a bottom portion of the back surface of the protection pocket and a second free end;
a strap return affixed to a top portion of the back surface of the protection pocket; and
an adjustable strap fastener comprising a top attachment patch disposed adjacent the second free end of the adjustable attachment strap and a bottom attachment strip disposed adjacent the first end of the adjustable attachment strap, wherein when in the attached configuration:
the second free end of the adjustable attachment strap loops about and leverages against the strap return; and
the top attachment patch and the bottom attachment strip mate at a select location along a length of the bottom attachment strip.

14. The soft-sided smartphone mounting holster of claim 13, wherein the strap return comprises a strap-reversing loop.

15. The soft-sided smartphone mounting holster of claim 11, wherein the protection pocket, the closure flap, the adjustable flap fastener, and the adaptable attachment mechanism are each formed of a malleable and shock-dampening material.

16. A method of attaching a holster housing an electronic device to an appendage or clothing article of a user, the holster including a protection pocket having an open top end, a closure flap, an adjustable flap fastener, and an adaptable attachment mechanism, the method comprising:
inserting the electronic device into the open top end of the protection pocket;
using the adjustable flap fastener, securing the closure flap to a select location on the protection pocket, the select location resulting in a combined height of the protection pocket and the closure flap that approximates the electronic device such that the electronic device is fully enveloped within the protection pocket and the closure flap; and
using the adaptable attachment mechanism, securing the holster about the user's appendage or the user's clothing article.

17. The method of claim 16, wherein the securing the closure flap to the select location on the protection pocket comprises mating a top securement patch affixed to the closure flap to the select location along a length of a bottom securement strip affixed to a front surface of the protection pocket.

18. The method of claim 17, wherein the securing the holster about the appendage or the clothing article comprises:
positioning the back surface of the protection pocket adjacent to the appendage or the clothing article;
extending an adjustable attachment strap of the adaptable attachment mechanism over the appendage or the clothing article such that the appendage or the clothing article is disposed between the back surface of the protection pocket and the adjustable attachment strap;
extending a free end of the adjustable attachment strap through a strap-reversing loop of the adaptable attachment mechanism;
reversing the free end of the adjustable attachment strap about the strap-reversing loop;
leveraging the free end of the adjustable attachment strap against the strap-reversing loop until the adjustable attachment strap achieves a desired tightness; and
using an adjustable strap fastener of the adaptable attachment mechanism, securing the free end of the adjustable attachment to maintain the desired tightness.

19. The method of claim 18, wherein the securing the free end of the adjustable attachment strap comprises mating a top attachment patch affixed to the closure flap to the select location along a length of a bottom attachment strip affixed to the back surface of the protection pocket.

20. The method of claim 16, wherein the protection pocket, the closure flap, the adjustable flap fastener, and the adaptable attachment mechanism are each formed of a malleable and shock-dampening material.
